(19) United States
(12) Patent Application Publication
(10) Pub. No.: US 2008/0035667 A1
(43) Pub. Date: Feb. 14, 2008

(54) Liquid delivery system

(75) Inventor: Michael J. Valenti, Rochester, NY (US)

Correspondence Address: IP GROUP OF DLA PIPER US LLP, ONE LIBERTY PLACE, 1650 MARKET ST, SUITE 4900, PHILADELPHIA, PA, 19103, US

(73) Assignee: OSG Norwich Pharmaceuticals, Inc., West Chester, PA (US)

(21) Appl. No.: 11/789,652

(22) Filed: Apr. 25, 2007

Related U.S. Application Data
(60) Provisional application No. 60/811,670, filed on Jun. 7, 2006.

(51) Int. Cl. B67D 5/08

(52) U.S. Cl. 222/1; 222/56

(57) ABSTRACT

A liquid supply system supplies liquid to a hopper upon liquid within the hopper reaching a low liquid level. The liquid may be heated within a liquid reservoir and within a liquid conduit between the reservoir and the hopper.

### CROSS REFERENCE TO RELATED APPLICATION

This application claims the benefit of U.S. provisional patent application No. 60/811,670, entitled “Liquid Delivery System,” and filed Jun. 7, 2006.

### TECHNICAL FIELD

The invention relates to liquid delivery systems. More specifically, the invention provides a system that may maintain a liquid at a proper temperature while dispensing the product from a reservoir to a hopper.

### BACKGROUND INFORMATION

Pharmaceutical capsules are made by supplying a liquid with solids in suspension therein to an encapsulator. Proper agitation must be maintained to ensure the suspended particles remain evenly dispersed within the liquid. The desired temperature of the liquid must be maintained as it is supplied to the encapsulator, and the solids must remain in suspension in the liquid. Any failure to maintain the liquid temperature or to maintain the solids in suspension will not only degrade the quality of the final product, but could also cause a blockage within the liquid flow path. At the same time, a substantially continuous flow of liquid should be supplied to the encapsulator to maximize the efficiency with which the capsules are manufactured.

In the past, liquid has been supplied to an encapsulator by a hopper. The heated liquid within the hopper was added manually, using a pitcher or other similar container to transfer the liquid from a liquid reservoir to the hopper. This method has raised issues of safety for the workers performing a task. Therefore, an automatic method of refilling the hopper as needed is desirable to minimize the need to expose personnel to potential safety risks, and to provide better temperature control throughout the filling process.

### SUMMARY

An apparatus and method are provided for automatically filling a hopper that supplies another machine with a liquid. As used herein, a liquid includes any fluid, including but not limited to a solution, a suspension, a matrix, etc. The apparatus includes a liquid reservoir and a hopper, with a liquid-level sensor structured to measure the level of liquid within the hopper. A liquid flow path connects the liquid reservoir with the hopper, and includes a valve that is structured to selectively permit or resist the flow of liquid through the liquid flow path in response to the sensor. A desirable liquid temperature or temperature range can be substantially evenly maintained throughout the system, and if needed, the system provides adequate agitation to maintain homogeneity of the liquid (e.g., a suspension).

When the level of liquid within the hopper reaches a first pre-determined level, the sensor will cause the valve to permit the flow of liquid from the liquid reservoir to the hopper, until the liquid level within the hopper reaches a second pre-determined level.

### DESCRIPTION OF THE DRAWINGS

For purposes of illustration, the drawings show selected, representative structures, it being understood that the invention is not limited to the precise arrangements and instrumentalities shown.

FIG. 1 is a partially schematic side view of a liquid supply system.

FIG. 2 is a partially schematic side view of another embodiment of a liquid supply system.

FIG. 3 is a partially schematic side view of yet another embodiment of a liquid supply system.

Like reference characters denote like elements throughout the drawings.

### DETAILED DESCRIPTION

It will be appreciated that the following description is intended to refer to specific representative structures selected for illustration in the drawings and is not intended to define or limit this disclosure, other than in the appended claims.

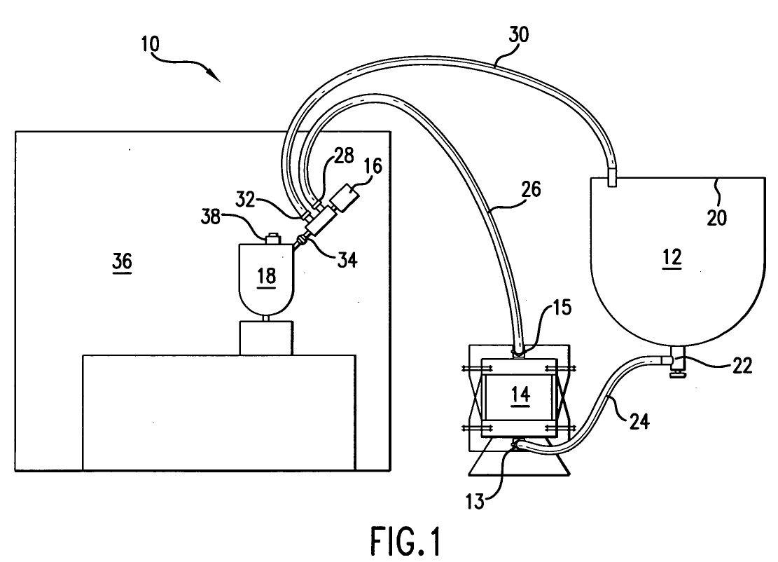

FIGS. 1-3 illustrate examples of an apparatus and method for automatically refilling a hopper with liquid. The example of the apparatus 10 illustrated in FIG. 1 includes a liquid reservoir 12, a pump 14, a three-way valve 16, and a hopper 18.

The hopper can be connected to an apparatus for producing capsules or other dosage forms comprising a matrix and a pharmaceutically active agent. Thus, the liquid moving from the hopper to the capsule-producing apparatus can comprise a formulation which is liquid under certain conditions of temperature and/or pressure. Such liquid can solidify after it has been delivered from the hopper and processed by the capsule-forming apparatus.

Suitable formulations that can be delivered through the liquid supply system include those comprising a polymeric material which melts at a certain temperature, admixed with a pharmaceutically active agent. This agent can be dissolvable in the melted polymeric material, or it can form a suspension in the melted polymeric material. Suitable polymeric materials include polyalkylene (oxides) such as polyethylene glycol and propylene glycol, waxes such as paraffin, and polysaccharides of any suitable molecular weight. For Example, if PEG is used, suitable member average molecular weights include about 600, about 800, about 1000, about 3500, about 4000, about 6000, about 10,000 or about 100,000 Other suitable polymeric materials are apparent to those of ordinary skill in the art.

The liquid formulations that can be delivered through the liquid delivery system can further comprise other excipients commonly used in formulating solid drug dosage forms. Suitable excipients include sugars, such as lactose, glucose and sucrose; starches, such as corn starch and potato starch; cellulose and its derivatives, such as sodium carboxymethyl cellulose, ethyl cellulose, and methyl cellulose; powdered tragacanth; malt; gelatin; talc; solid lubricants, such as stearic acid and magnesium stearate; calcium sulfate; vegetable oils, such as peanut oil, cottonseed oil, sesame oil, olive oil and corn oil; sugar alcohols such as sorbitol and mannitol; emulsifiers such as polysorbate 60, polysorbate 80 and sodium lauryl sulfate; coloring agents; flavoring agents; tableting agents, stabilizers; antioxidants; preservatives; water insoluble polymers such as poly(vinyl alcohol), polypyrrolidone and poly(acrylic acid); disintegrants such as alginic acid and croscarmelose; lubricants such as magnesium stearate, stearic acid and talc; glidants such as silicon dioxide; coloring agents, such as the FD&C dyes; and sweeteners and flavoring agents such as aspartame, saccharin, menthol, peppermint, and fruit flavors. Other suitable excipients for formulating a liquid formulation for delivery through the liquid delivery system are apparent to those of ordinary skill in the art, as described for example in Remington's Pharmaceutical Science, 17th edit., Mack Publishing Company, Easton, Pa. (1985), the entire disclosure of which is herein incorporated by reference.

As discussed above, the liquid may further comprise any suitable pharmaceutical agents or agents for delivery in tablet or pill form. Examples of suitable pharmaceutically active agents include, but are not limited to, antibiotics such as the glycopeptide antibiotics, gentamicin, penicillin and its derivatives such as amoxicillin, and erythromycin; analgesics such as NSAIDs (e.g., aspirin and other salicylates, ibuprofen, naproxen, nabumetone and COX-2 inhibitors such as celecoxib), opioids and the like; and antivirals such as nucleic acid polymerase inhibitors (e.g. acyclovir, gancyclovir and valgancyclovir), ribavirin, amantadine, pleconaril and interferons; and combinations of these.

Suitable opioids include, but are not limited to, alfentanil, buprenorphine, butorphanol, codeine, dezocine, dihydrocodeine, fentanyl and fentanyl congeners (e.g., sufentanil, alfentanil, lofentanil, carfentanil, remifentanil, trefentanil, and mirfentanil), hydrocodone, hydromorphone, levorphanol, meperidine (pethidine), methadone, morphine, nalbuphine, oxycodone, oxymorphone, pentazocine, propiram, propoxyphene, tilidine, tramadol, the pharmaceutically acceptable acid addition salts thereof, and combinations of these.

As used herein, a “glycopeptide antibiotic” refers to oligopeptide (e.g., heptapeptide) antibiotics, characterized by a multi-ring peptide core optionally substituted with saccharide groups, such as vancomycin or vancomycin-B. Suitable glycopeptides for use in the liquid formulation include A477, A35512, A40926, A41030, A42867, A47934, A80407, A82846, A83850, A84575, AB-65, Actaplanin, Actinoidin, Ardacin, Avoparcin, Azureomycin, Balhimycin, Chloroorientiein, Chloropolysporin, Decaplanin, N-demethylvancomycin, Eremomycin, Galacardin, Helvecardin, Izupeptin, Kibdelin, LL-AM374, Mannopeptin, MM45289, MM47756, MM47761, MM49721, MM47766, MM55260, MM55266, MM55270, MM56597, MM56598, OA-7653, Orenticin, Parvodicin, Ristocetin, Ristomycin, Synmonicin, Teicoplanin, UK-68597, UK-69542, UK-72051, vancomycin, vancomycin B, their pharmaceutically acceptable salts and combinations thereof, for example as described in “Glycopeptides Classification, Occurrence, and Discovery,” by Rao R C and Crandall L W, in Drugs and the Pharmaceutical Sciences, Volume 63, Ramakrishnan N (ed.), Marcal Dekker, Inc., the entire disclosure of which is herein incorporated by reference. A “glycopeptide antibiotic” also includes the general class of glycopeptides disclosed above on which the sugar moiety is absent; i.e., the aglycone series of glycopeptides.

The liquid reservoir 12 in the illustrated example is a heated reservoir, for example, a Groen NE-30 vessel or a Groen NE-60 vessel. As used herein, an item which is “heated” is defined as an item which is structured to provide or retain heat, or a combination of both. Examples of heated items include items incorporating a heating element such as an electrical heating element or a conduit for heated liquid or gas to flow around the heated item, or as being sufficiently well insulated so that the temperature of the contents will remain within a desired range for a desired amount of time. The reservoir 12 includes a top cover 20 and a bottom valve 22. The reservoir 12 may further include a means for mixing or agitating liquid within the reservoir, thereby preserving the homogeneity of the liquid. Agitation is particularly useful if the liquid comprises a suspension. “Agitating” and “mixing” are used interchangeably herein.

A hose 24 leads from the bottom valve 22 of the liquid reservoir 12 to an inlet 13 of a pump 14. The illustrated example of the hose 24 is a BIOFLEX hose, available from Aflex Hose Ltd. Some example of the hose 24 and other hoses described herein, may be heated. Methods of heating the hose 24, and other hoses, include electric heating elements contained within the walls of the hose, or passageways defined within the walls of the hose to permit heated steam or fluid to flow therethrough. Examples of such heated hoses include embodiments of the above-mentioned BIOFLEX hose.

The illustrated example of the pump 14 is a Warren Rupp SANDPIPER double diaphragm ball valve pump. Other pumps may be used to transfer the liquid from the heated reservoir to the heated hopper. These pumps will fall into two categories: rotodynamic pumps and positive displacement pumps. Examples of each type include centrifugal, lobe, gear, peristaltic, cyclic, progressive cavity, and others. Some examples of the pump 14 may be heated, for example, by a blanket substantially surrounding the pump 14 and having heating elements therein. A second hose 26 leads from the outlet 15 of the pump 14 to the inlet 28 of the three-way valve 16. The hose 26 may be of similar construction to the hose 24.

The illustrated example of a three-way valve 16 is a pneumatic actuated valve available from Swagelok Company, located in Bolon, Ohio. Some examples of the valve 16 may be heated, for example, by a blanket having heating elements therein substantially surrounding the valve 16. A third hose 30, which in the illustrated example is also a BIOFLEX hose, leads from the first outlet 32 of the three-way valve 16 to the top 20 of the liquid reservoir 12.

The second outlet 34 of the three-way valve 16 leads to the hopper 18, which in the illustrated example feeds an encapsulator 36. Some examples of the hopper 16 are equipped with an agitator mechanism. A sensor 38 is structured to sense the level of liquid within the hopper 18, and is operatively connected to the three-way valve 16.

The heating of the liquid reservoir 12, hoses 24, 26, 30, and blankets covering the pump 14 and valve 16, may in some examples be controlled by proportional integral differential (PID) controllers that are operatively connected to temperature sensors. Such controllers are well-known in the art, the use of a PID controller facilitates maintaining a temperature between a desired minimum and maximum temperature which will vary depending on the liquid being used. For the example of a suspension of vancomycin HCl and propylene glycol or polyethylene glycol, the liquid may be maintained within a temperature range of about 60° C. to about 70° C., and more preferably may be about 68° C. The PID also permits a gradual reduction in the heat output of the various heat elements as a pre-determined temperature is approached, thereby avoiding overshooting the desired temperature. One example of a suitable PID controller is made by Red Lion.

In use, liquid within the liquid reservoir 12 is pumped by the pump 14 through the first hose 24, and second hose 26 into the inlet 28 of the three-way valve 16. If there is sufficient liquid within the hopper 18 to continue to feed the encapsulator 36, the liquid is directed by the valve 16 through the outlet 32 and hose 30 back into the liquid reservoir 12. The substantially continuous pumping of liquid through the pump 14 and valve 16, and then back into the reservoir 12, ensures that the liquid within the reservoir 12 remains mixed, thereby ensuring the homogeneity of the liquid.

When the level of liquid within the hopper 18 reaches a predetermined low level, the sensor 38 will actuate the three-way valve 16 so that liquid is now directed through the outlet 34 instead of the outlet 32, and into the hopper 18 until the liquid level within the hopper 18 reaches a predetermined high level. At this point, the sensor 38 will again actuate the three-way valve 16 to shut off the flow of liquid through the outlet 34, directing additional flow of liquid through the outlet 32.

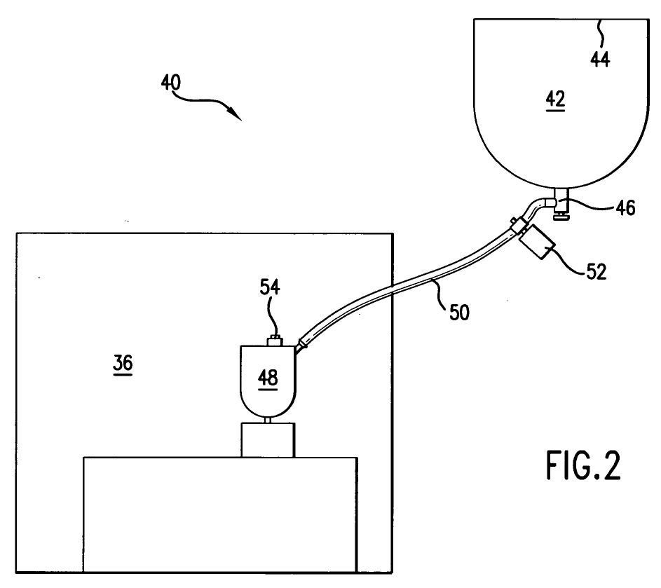

Another embodiment of a liquid delivery system 40 is illustrated in FIG. 2. The system 40 includes a liquid reservoir 42 having a top cover 44 and a bottom valve 46. The reservoir 42 may be the same as the reservoir 12 of FIG. 1, and may in some examples include heating elements structured to heat a liquid therein to a desired temperature, and optionally agitation mechanisms for agitating or mixing the liquid and maintaining its homogeneity.

A liquid flow path extends from the liquid reservoir 42 to the hopper 48, and includes the hose 50 and valve 52. The hose 50 is similar to the hoses 24, 26, 30 in the system of FIG. 1, and may in some examples be a BIOFLEX hose, which hose is optionally heated. The valve 52 in some examples is a pneumatic actuated valve, controlled by a sensor 54 that is structured to measure the liquid level within the hopper 48. The valve 52 may be heated, for example, by substantially surrounding the valve 52 with a blanket having heating elements therein. The various heated elements within the system 40 may be controlled by a PID controller to ensure that the liquid is heated to an appropriate temperature.

The liquid reservoir 42 is disposed above the hopper 48, so that when the valve 52 is open, liquid will flow from the liquid reservoir 42 to the hopper 48 due to gravity. The valve 52 is closed except when the sensor 54 senses that the level of liquid within the hopper 48 has dropped below a predetermined low level. At this point, the sensor 54 will actuate the valve 52, permitting liquid to flow from the liquid reservoir 42 into the hopper 48 until the level of liquid in the hopper 48 reaches a predetermined high level. Once the desired liquid level is reached within the hopper 48, the sensor 54 will again actuate the valve 52 to close the valve 52.

At the end of each fill cycle when transferring a suspension using the system 40, the hose 50 may be opened to the atmosphere or to a controlled gas such as to Nitrogen or Argon, ensuring that liquid within the hose 50 is substantially drained into the hopper 48, instead of remaining in the hose where the suspended solids may come out of suspension. The desired fill level of the hopper 48 may be adjusted downward prior to the last time the hopper 48 is filled during a production cycle to compensate for the additional fluid within the hose 50.

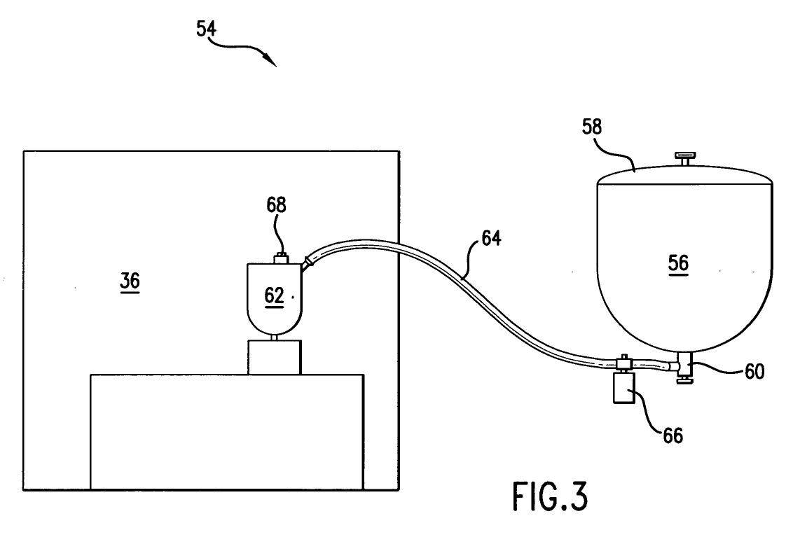

Referring to FIG. 3, another embodiment of liquid delivery system 54 is illustrated. The system 54 includes a closed top 58. The liquid reservoir 56 includes a bottom valve 60. The liquid reservoir 56 is pressurized with a gas such as Nitrogen or Argon so that the pressure within the liquid reservoir 56 biases liquid contained therein out through the valve 60. Some examples of the liquid reservoir 56 may be heated, and the temperature may be controlled by a PID controller. The reservoir 56 may also include a mixing or agitation mechanism.

A liquid flow path extends between the liquid reservoir 56 and the hopper 62. The liquid flow path in the illustrated example includes a hose 64 and a valve 66 structured to control the flow of product through the hose 64. The hose 64 is similar to the hoses 24, 26, 30 and 50 of the systems of FIGS. 1 and 2, and may be a BIOFLEX hose, and/or a heated hose. The valve 66 is similar to the valve 52 in FIG. 2, and may in some examples be pneumatic-actuated valve. The valve 66 is controlled by a sensor 68 that is structured to sense a level of liquid within the hopper 62. When the level of liquid within the hopper 62 reaches a pre-determined low level, the sensor 68 will actuate the valve 66, which is normally closed, to open the valve 66. Pressure within the fluid reservoir 56 will force fluid through the valve 60, valve 66 and hose 64 into the hopper 62 until a desired high liquid level is reached. At this point, the sensor 68 will again actuate the valve 66 to close the valve 66. Upon valve 66 actuation the liquid flow will be stopped. A controlled gas such as Nitrogen or Argon may be introduced into hose 64 to ensure that no substantial amount of liquid remains in the hose 64, where the solid may come out of suspension. The invention is particularly useful for feeding liquids such as formulations of polyethylene glycol, for example, a formulation of polyethylene glycol commonly known as PEG 6000, having a number average molecular weight of about 6,000. Formulations of vancomycin HCl, including suspensions of vancomycin HCL and polyethylene glycol, which must be kept within a specific temperature range during delivery, may be delivered using the invention. Additionally, formulations of paraffin or other liquids which are delivered heated to an encapsulator and then allowed to cool may be delivered by the invention.

A method of automatically refilling a hopper for an encapsulator or other machine with liquid when the level of liquid within the hopper drops below a predetermined level is thus provided. The system minimizes the risk to personnel that would accompany manually filling the hopper. Some examples of the system ensure that the liquid is heated to a desired temperature as the liquid is being delivered to the hopper, or that the liquid remains within a desired temperature range during delivery of the liquid. Other examples of the system ensure that the liquid remains mixed (for example, to ensure homogeneity and to maintain the integrity of a suspension) as it is delivered to the hopper.

While specific embodiments of the invention has been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of the invention which is to be given the full breadth of the appended claims and any and all equivalents thereof.

1. An apparatus for delivering a liquid to a hopper, the apparatus comprising:
A heated liquid reservoir;
a hopper;
a liquid level sensor structured to measure a level of liquid within the hopper;
a valve operatively connected to the liquid level sensor; and
a heated liquid flow path in communication with the liquid reservoir and the hopper, the valve being structured to selectively open and close the liquid flow path; whereby the sensor causes the valve to permit liquid to flow into the hopper upon liquid within the hopper reaching a first predetermined liquid level, and resists any flow of liquid into the hopper upon the liquid level within the hopper reaching a second predetermined level.

2. The apparatus according to claim 1, wherein the liquid is heated to a temperature of about 68° C. (154° F.).

3. The apparatus according to claim 1, wherein the liquid flow path comprises:
a first liquid conduit leading from the liquid reservoir to the three way valve;
a second liquid conduit leading from the three way valve to the hopper;
a third liquid conduit leading from the three way valve to the liquid reservoir; and
a pump disposed along the first liquid conduit; whereby liquid is recirculated between the valve and liquid reservoir when the level of liquid is above a first predetermined level, and liquid is dispensed from the three way valve to the hopper when the level of liquid falls below the first predetermined level until the level of liquid reaches a second predetermined level.

4. The apparatus according to claim 3, wherein the liquid reservoir is heated.

5. The apparatus according to claim 4, wherein the first liquid conduit, second liquid conduit, and third liquid conduit are heated.

6. The apparatus according to claim 5, wherein the first liquid conduit, second liquid conduit, and third liquid conduit include heating elements therein.

7. The apparatus according to claim 5, wherein the pump is heated.

8. The apparatus according to claim 7, wherein the pump is heated by a blanket having a heating element substantially surrounding the pump.

9. The apparatus according to claim 5, wherein the three way valve is heated.

10. The apparatus according to claim 19, wherein the three way valve is heated by a blanket having a heating element substantially surrounding the pump.

11. The apparatus according to claim 1, wherein the liquid reservoir is disposed above the hopper, and the liquid flow path is structured to permit liquid to flow from the reservoir to the hopper due to gravity.

12. The apparatus according to claim 11, wherein the liquid reservoir is heated.

13. The apparatus according to claim 12, wherein the liquid flow path is heated.

14. The apparatus according to claim 13, wherein the liquid flow path includes heating elements therein.

15. The apparatus according to claim 1, wherein the liquid reservoir is pressurized; whereby the pressurization biases the liquid towards the liquid flow path.

16. The apparatus according to claim 15, wherein the liquid reservoir is heated.

17. The apparatus according to claim 16, wherein the liquid flow path is heated.

18. The apparatus according to claim 17, wherein the liquid flow path includes heating elements therein.

19. The apparatus according to claim 1, wherein the second predetermined level is higher than the first predetermined level.

20. The apparatus according to claim 1, wherein the hopper is structured to feed the liquid to an encapsulator.

21. The apparatus according to claim 1, wherein the liquid comprises a formulation of propylene glycol or polyethylene glycol.

22. The apparatus according to claim 21, wherein the liquid comprises a pharmaceutically active agent.

23. The apparatus according to claim 22, wherein the pharmaceutically active agent is selected from the group consisting of antibiotics, analgesics, and antivirals.

24. The apparatus according to claim 23, wherein the pharmaceutically active agent is vancomycin.

25. The apparatus according to claim 24, wherein the liquid comprises a suspension of vancomycin HCl and polyethylene glycol.

26. The apparatus according to claim 25, wherein a temperature of the liquid is maintained between about 60° C. to about 70° C.

27. The apparatus according to claim 26, wherein the temperature of the liquid is maintained at about 68° C.

28. The apparatus according to claim 1, further comprising an agitator within the liquid reservoir.

29. A method of delivering a liquid to a hopper, the method comprising:
providing a liquid reservoir, a hopper, and a liquid flow path from the liquid reservoir to the hopper;
measuring a level of liquid within the hopper;
dispensing liquid into the hopper when the level of liquid falls below the first predetermined level until the level of liquid reaches a second predetermined level; and
wherein the liquid comprises a pharmaceutically active agent.

30. The method according to claim 29, further comprising heating the liquid reservoir.

31. The method according to claim 29, further comprising heating the liquid flow path.

32. The method according to claim 29, further comprising agitating the liquid within the liquid reservoir and within the hopper.

33. The method according to claim 29, further comprising recirculating a liquid between the liquid reservoir and the hopper when the level of liquid is above a first predetermined level.

34. The method according to claim 29, wherein the second predetermined level is higher than the first predetermined level.

35. The method according to claim 29, further comprising feeding the liquid from the hopper to an encapsulator.

36. The method according to claim 29, wherein the liquid comprises a formulation of propylene glycol or polyethylene glycol.

37. The method according to claim 29, wherein the pharmaceutically active agent is selected from the group consisting of antibiotics, analgesics, and antivirals.

38. The method according to claim 37, wherein the pharmaceutically active agent is vancomycin.

39. The method according to claim 38, wherein the liquid comprises a suspension of vancomycin HCl and polyethylene glycol.

40. The method according to claim 39, wherein a temperature of the liquid is maintained between about 60° C. to about 70° C.

41. The method according to claim 29, wherein the temperature of the liquid is maintained at about 68° C.
